(19) United States
(12) Patent Application Publication
(10) Pub. No.: US 2008/0028581 A1
(43) Pub. Date: Feb. 7, 2008

(54) Screen, in particular for manufacturing nonwoven fabrics by means of a gaz jet or liquid jet solidification process

(75) Inventor: Gilberto Dante Ronzani, Kiefersfelden (DE)

Correspondence Address: BIRCH STEWART KOLASCH & BIRCH, PO BOX 747, FALLS CHURCH, VA, 22040-0747, US

(73) Assignee: Stork Prints Austria Gmbh, Langkampfen (AT)

(21) Appl. No.: 11/882,545

(22) Filed: Aug. 2, 2007

(30) Foreign Application Priority Data
Aug. 4, 2006 (EP) 06 016 367.2

(51) Int. Cl. D04H 1/46; B44C 1/22; C25D 5/02

(52) U.S. Cl. 28/104; 205/122; 216/41; 216/48

(57) ABSTRACT

The invention relates to a screen, in particular for manufacturing nonwoven fabrics by means of a gas or liquid jet bonding process, and to a method for manufacturing it. Such a screen has a screen body (10) with an upper side (11) for applying a nonwoven material to be bonded and a rear side (12) opposite from the upper side (11), the screen body (10) having a multiplicity of through-openings (14) running from the upper side to the rear side and also lower-lying regions (16) in the upper side (11) having contours that run in a way corresponding to a desired pattern. In order to improve such a screen in its function and provide an increased embossing effect, it is provided according to the invention that the cross section of the through-openings (14) substantially remains the same or increases from the upper side (11) to the rear side (12). The screen body (10) may be structured by etching, electroplating or by a combination thereof. Furthermore, suitably chosen laser radiation may also be used for forming the through-openings and/or the lower-lying regions.

The invention relates to a screen, in particular a screen as used for manufacturing nonwoven fabrics by means of a gas jet or liquid jet bonding process.

In the manufacture of nonwovens, as used in particular in the household, generally for sanitary purposes or for hygiene-related articles, nonwoven materials, such as for example fibers, filaments, flakes, ribbons or the like, are applied to a screen, in order to form there a nonwoven contiguous web as a result of a bonding operation. For the felting or bonding of the nonwoven materials, they are pressed against the screen, for example by a water jet under high pressure, intermingled and felted with one another. Instead of column-like or comb-like water jets, column-like or comb-like gas jets may also be used, leading to intermingling and felting of the fiber materials. Furthermore, instead of water, other liquids, including nonaqueous liquids, can be used.

Appropriate configuration of the surface of the screens allows patterns that raise up from the general background of the nonwoven fabric in the manner of a relief to be impressed into the resulting nonwoven.

Already known for this purpose are woven wire cloths, templates or screens for which woven wire cloths of copper are used, having depressions or elevations of the screen surface at salient points. On account of the depressions or elevations, a greater or lesser amount of fibers or other nonwoven materials can be made to accumulate or thin out at a specific point. Since woven wire cloths usually do not have the necessary stiffness to withstand the gas, liquid or water pressure, it is usually necessary to use a perforated steel drum to stabilize and support the woven wire cloth screen.

The use of woven screens has the disadvantage that fibers and other constituents of the nonwoven material can get stuck at the crossing points of warp and weft, so that the nonwoven web forming cannot be detached from the screen intact, but adheres to it to a greater or lesser extent.

EP 0 776 391 B1 already discloses a device for manufacturing a non-woven unpatterned cloth by means of pressurized water jets in which a cylindrical, rotatable drum that has a multiplicity of micro-openings on its surface is used. These micro-openings may in this case be distributed in any randomized or regular manner on the surface of the drum. The micro-openings have in this case been produced by means of the known technique of silk screen printing with electrolytic deposition.

In order to produce nonwoven material webs or the like with embossed surfaces, topographical screens or support members that have a multiplicity of through-openings or drainage apertures are used, as shown in EP 0 705 932 B1. These drainage apertures taper from the upper side to the rear side of the support member. The angle of the taper in the case of this known screen or support member must be neither too large nor too small and must be set with regard to the thickness of the support member in order on the one hand to obtain an adequate drainage effect and on the other hand to obtain on the upper side of the support member a structured surface desired for the background structure of the nonwoven fabric.

In order to produce reliefs in the nonwoven, the surface of the support member or screen has depressions in a way corresponding to the desired patterns.

On account of the tapering of the through-openings running from the upper side to the rear side of the support member, there is the risk of these becoming clogged by fiber material, which can considerably impair the function of the support member and necessitate frequent servicing of the same.

Against this background, the invention is based on the object of providing a further screen, in particular for manufacturing nonwoven fabrics by means of a jet bonding process, that is in particular improved in its function and provides an increased embossing effect.

This object is achieved by the screen as claimed in claim 1 and by the methods as claimed in claims 15, 22 and 23. Advantageous developments and refinements of the invention are described in the subclaims.

Therefore, in the case of a screen comprising a screen body with an upper side for applying a nonwoven material to be bonded, a rear side opposite from it, a multiplicity of through-openings running from the upper side to the rear side, and with lower-lying regions in the upper side having contours that run in a way corresponding to a desired pattern, it is provided according to the invention that the cross section of the through-openings substantially remains the same or increases from the upper side to the rear side.

As a result, this on the one hand allows the effect to be achieved that it is impossible in practice for fiber fragments, filaments, filament fragments or other fiber materials that undesirably get into the through-openings to become wedged, whereby clogging of the through-openings of the screen can be effectively prevented. On the other hand, the embossing effect can also be improved, since the flow resistance of the screen is reduced in the region of the depressions, in particular whenever the through-openings widen conically toward the rear side, so that the medium acting on the nonwoven material for the bonding and felting can also flow out from the regions adjacent the depressions into the depressions and thereby entrain fiber material, which leads to an improved relief formation.

Furthermore, the function of the screen according to the invention can also be improved by the fact that, in particular when liquids are used for the bonding of the felt material, these liquids can be carried away more easily in the region of the depressions, which facilitates the later drying of the nonwoven fabric manufactured on the screen according to the invention.

In the case of an advantageous refinement of the invention, it is provided that the lower-lying regions have a uniform depth, which is not greater than approximately three quarters of the thickness of the screen body, preferably approximately equal to two thirds of the thickness of the screen body.

In order to make the relief formation, that is the contours of the desired relief, more distinct or less distinctly identifiable, it is expedient if the lower-lying regions are bounded along their edges by side walls which either run substantially perpendicularly to the plane of the screen or are inclined in the manner of a slope at an angle of less than 45° to the perpendicular of the plane of the screen or form an undercut with an angle of less than 20° with respect to the perpendicular to the plane of the screen.

Particularly good results in the manufacture of the nonwoven material are achieved if the opening ratio, that is to say the ratio of the surface area of all the openings to the total surface area of the screen, lies in the range from 1% to 30%, in particular in the range from 5% to 20%, preferably at 7%, the opening ratio in the region of the lower-lying regions expediently being the same as or greater than outside them.

In the case of another refinement of the invention, it is provided that the lower-lying regions are interrupted by pattern-forming, raised regions, which protrude beyond the plane of the upper side of the screen body, the opening ratio in the region of the raised regions being at least less than the opening ratio in the region of the lower-lying regions, preferably equal to zero. This allows a pattern to form in the nonwoven fabric, impressed into the background in the manner of a relief.

Depending on the type of medium that is used for the bonding of the nonwoven material on the screen, the cross section of the through-openings may be circular or noncircular. In the latter case, oval, elliptical or quadrangular forms are preferred, which may also be slit-shaped.

In the case of slit-shaped and noncircular through-openings, the cross section of which defines a longitudinal direction, it is provided that the through-openings are arranged according to the desired opening ratio and/or required stability of the screen with their longitudinal directions parallel to one another, alternately parallel and perpendicular to one another, or in randomized alignment to one another.

In order to ensure good stability of the screen in the case of a high opening ratio, it is expedient if the through-openings are arranged in such a way that immediately adjacent each of the through-openings there lie six through-openings that are spaced equally apart from one another.

In the case of another refinement of the invention, it is provided that adjacent each of the through-openings there lie three to ten through-openings that are spaced at different intervals from one another. This allows the effect to be achieved that the nonwoven fabric manufactured on the screen has a vividly structured background surface.

Such a structuring can also be achieved if the openings are arranged in a randomized or pseudo-randomized manner in relation to one another.

In principle, it is possible for the screen body to consist of nonmetallic materials, such as for example plastic, ceramic, natural wood or lacquer materials that are suitable for forming stable two-dimensional elements, composite materials or a combination thereof. However, it is advantageous if the screen body consists of metal, preferably of a metal that can be deposited on an electrode in an electrolytic bath, in particular of nickel, copper or aluminum or a mixture thereof.

According to the invention, a screen that is used in particular for manufacturing nonwoven fabrics can be produced by the following steps:
providing a screen body with an upper side for applying a nonwoven material to be bonded and a rear side opposite from the upper side, the screen body having a multiplicity of through-openings running from the upper side to the rear side, the cross section of which substantially remains the same or increases from the upper side to the rear side, and
forming lower-lying regions in the upper side of the screen body in a way corresponding to the desired pattern, the forming of the lower-lying regions preferably being performed by
applying an etching mask to the screen body in a way corresponding to a desired pattern, and
subsequently etching the screen body from the upper side to a desired depth.

Instead of the formation of the depressed or lower-lying regions by means of etching, it is also possible for the upper side of the screen body to be eroded to a desired depth according to a pattern to form the lower-lying regions. The formation of the lower-lying regions can also be achieved, however, by removal according to a pattern or ablation according to a pattern of the screen body material from the upper side of the screen body by means of laser radiation. In this case, it is expedient if laser radiation of a wavelength corresponding to the absorption properties of the screen body material is chosen for the removal of the screen body material.

The screen body is expediently provided galvanically.

However, it is also possible for a planar plate or a hollow cylinder of metal or non-metal to be provided with a multiplicity of through-openings running from the upper side to the rear side by means of laser radiation to provide the screen body.

A method for producing a screen without material-removing techniques is distinguished by the following steps:
providing a galvanic screen body film with an upper side and a rear side opposite from it and also a multiplicity of through-openings,
applying an electroplating mask in a way corresponding to a desired pattern on the screen body film,
galvanically depositing screen body material outside the lower-lying regions onto the upper side of the screen body film to a thickness that corresponds substantially to the later thickness of the lower-lying regions,
removal of the electroplating mask and
galvanically depositing screen body material on the resulting screen body structure to a thickness desired for the screen body while retaining the through-openings that run from the upper side of the screen body to its rear side.

A further method for producing a screen in which the pattern structures are produced without screen-material removing techniques has the following steps:
providing a galvanic screen body film with an upper side and a rear side opposite from it and also a multiplicity of through-openings,
applying an electroplating mask in a way corresponding to a desired pattern on the screen body film,
galvanically depositing screen body material outside the lower-lying regions onto the upper side of the screen body to a thickness that corresponds substantially to the later thickness of the lower-lying regions, and
removal of the electroplating mask.

To be able to manufacture a nonwoven fabric that has not only a relief-like embossed surface but also a background structure, it is advantageous if, before or after the forming of the lower-lying regions or before the application of an electroplating mask for galvanically producing raised regions, the upper side of the screen body is etched using an etching mask in a way corresponding to the respectively desired background structure of the nonwoven fabric to be manufactured.

The invention is explained in more detail below by way of example on the basis of the drawing, in which:

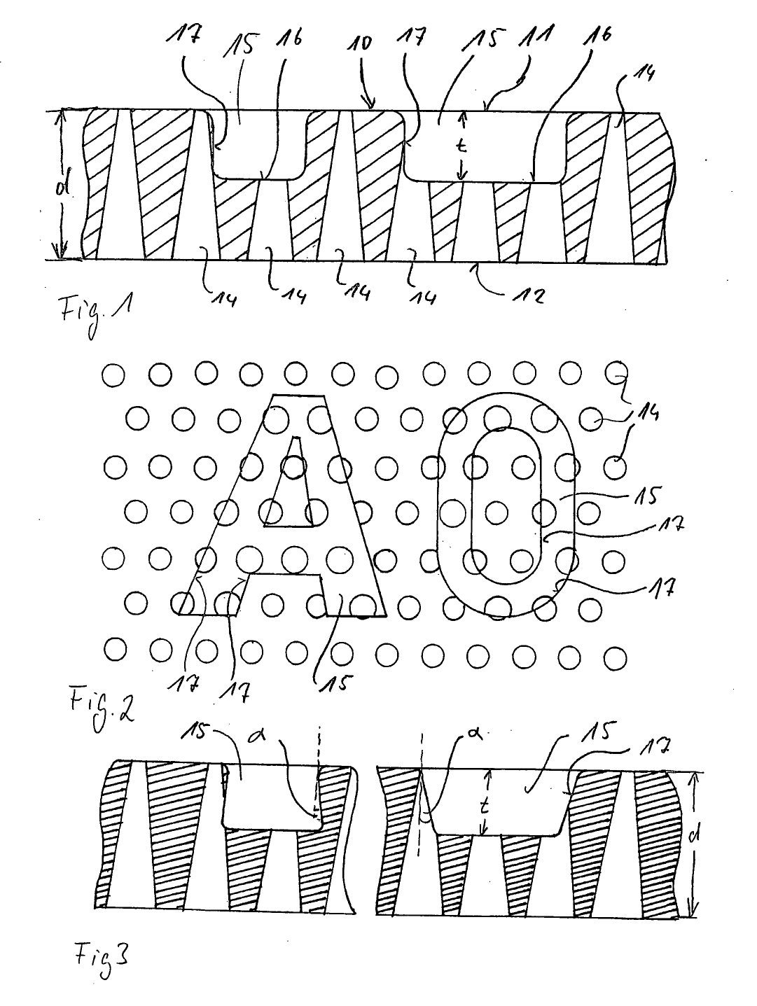

FIG. 1 shows a schematic sectional representation of a screen according to the invention;

FIG. 2 shows a schematic plan view of another screen according to the invention;

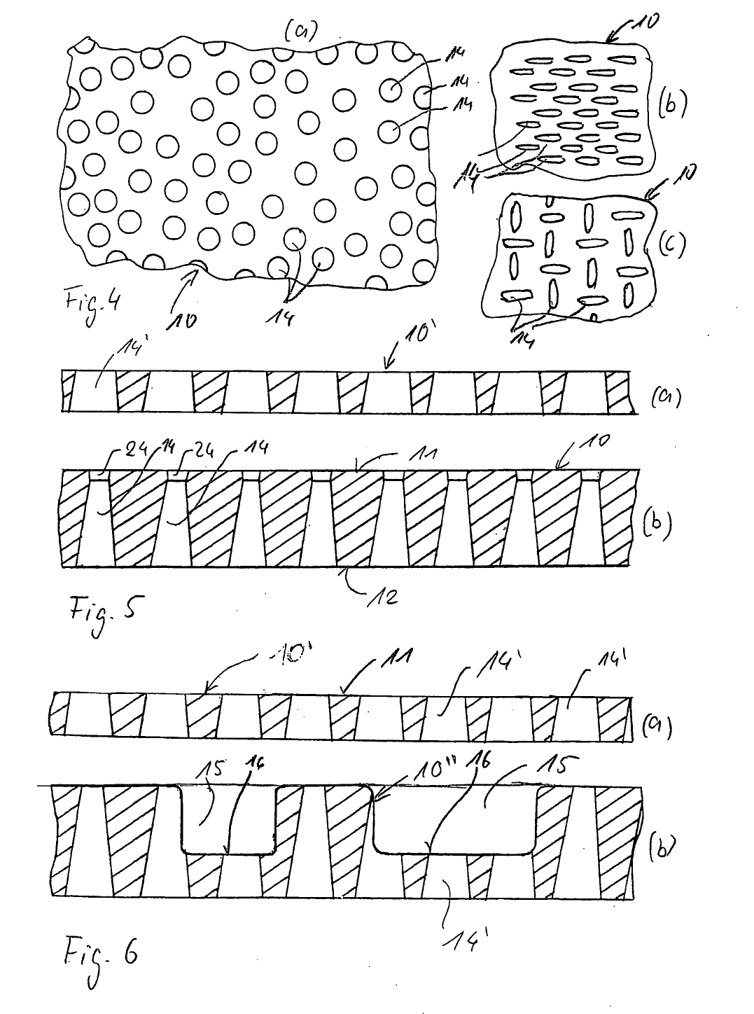

FIG. 3 shows schematic sectional representations of further refinements of the invention;

FIG. 4 shows schematic plan views of screens according to the invention to explain the distribution of through-openings;

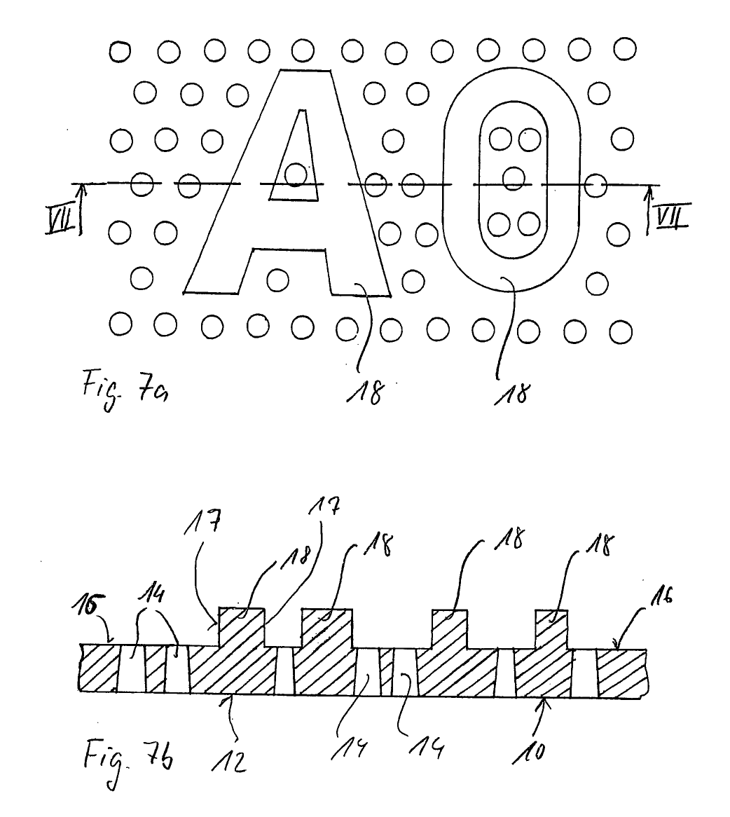

FIG. 5(a) shows a schematic sectional representation of a galvanic screen body film;

FIG. 5(b) shows a schematic sectional representation of a screen body or blank;

FIG. 6(a) shows a representation corresponding to FIG. 5(a);

FIG. 6(b) shows a galvanic precursor of a screen according to the invention;

FIG. 7(a) shows a schematic plan view of a screen according to a further refinement of the present invention; and

FIG. 7(b) shows a section substantially along the line VII in FIG. 7(a).

In the various figures of the drawing, elements that correspond to one another are provided with the same designations.

As can be seen in FIG. 1, a screen, in particular a screen that is used for manufacturing nonwoven fabrics by means of a gas jet or liquid jet bonding process, has a screen body 10, which has an upper side 11 and a rear side 12 opposite from it. The upper side 11 of the screen body 10, that is to say the upper side of the screen, is the side onto which the nonwoven material to be bonded, that is to say fiber materials, filaments and other flake or ribbon materials suitable for non-woven webs, are applied during the manufacture of nonwoven fabrics. The rear side 12 of the screen body 10, opposite from the upper side 11 of the screen, is formed substantially by a surface area that is parallel to the upper side 11 and is preferably smooth. The screen may be a planar screen or else a cylindrical screen.

With appropriate choice of material, it is also conceivable to form the screen in strip form. For a strip-shaped screen, it is necessary to use a material of such a thickness that it is on the one hand flexible enough to be guided over a deflecting rollers, but on the other hand stable enough to withstand the pressure of a medium directed against the screen for the bonding process. Planar and cylindrical screens can preferably be produced galvanically—as explained in more detail below.

In order to permit draining away of the medium used during the bonding process, in particular the water used thereby, provided in the screen body 10 are a multiplicity of through-openings 14, the cross section of which remains the same or increases in a conically widening manner from the upper side 11 to the rear side 12, as shown in FIG. 1.

In order in the manufacture of nonwoven fabrics to structure the forming surface of the nonwoven in the manner of a relief during the bonding of the nonwoven material by means of suitable liquid or gas jets, depressions 15 are provided in the upper side 11 of the screen body 10, the bottoms 16 of which depressions form lower-lying regions that are bounded by side walls 17.

As can be seen particularly well in FIG. 2, the side walls 17 of the depressions 15 represent the contours of a desired pattern.

FIG. 2 shows a honeycomb form of arrangement of the through-openings, and also illustrates that the through-openings 14 in the region of the depressions have a greater diameter on the inlet side than the through-openings 14 lying outside the depressions, which is a result of the conical widening of the through-openings toward the rear side 12.

Depending on the desired sharpness of relief, it is possible to form the side walls perpendicularly to the plane of the screen or, in the case of cylindrical screens, perpendicularly to the respective tangential plane, as is represented in FIG. 1. However, it is also conceivable, as shown in FIG. 3, for the side walls 17 to form undercuts or slopes, as the left-hand and right-hand sides of FIG. 3 respectively show. The angle α of the side wall with the perpendicular to the screen surface in this case lies in the range from 0° to 20° in the case of undercuts, while it may be up to 45° for slopes.

Depending on the medium used for the bonding process, and depending on the pressures used, the through-openings may have different cross-sectional shapes and be distributed in various ways. FIG. 4 shows, for example, a randomized arrangement in which adjacent each of the round through-openings 14 there lie three to ten through-openings 14 that are spaced at different intervals from one another, while in the case of the regular honeycomb form of arrangement that is shown in FIG. 2 adjacent each through-opening 14 there lie six through-openings 14 that are spaced at equal intervals from one another.

However, noncircular, oval or rectangular cross sections may also be chosen for the through-openings 14, which may then also be slit-shaped, as shown in FIGS. 4(b) and (c). Depending on the desired opening ratio, that is to say the ratio of the total surface area of the openings to the total surface area of the screen, different arrangements may be provided. FIG. 4(b) shows, for example, an arrangement of through-openings 14 with slit-shaped cross section, the slits all being offset parallel to one another. FIG. 4(c) shows another arrangement, in which each through-opening 14 has eight associated adjacent through-openings, half of which are arranged parallel to it and the other half are arranged perpendicular to it.

As a further design element for the desired relief-like pattern on the surface of the nonwoven fabrics, the depth t of the depressions 15 may be varied. The depth t of the depressions 15 should expediently not be greater than approximately ¾ of the thickness d of the screen body. In particular, as represented in FIGS. 1 and 3, the depth may be approximately half the thickness of the screen body 10. Preferred, however, are depths t that are approximately ⅔ of the thickness d of the screen body 10.

Since the through-openings 14 have a cross section that remains the same or preferably widens from the upper side to the rear side, the opening ratio, that is to say the ratio of the surface area of all the openings to the total surface area of the screen, in the region of the depressions is the same as or greater than the opening ratio outside them. The opening ratio seen over the entire screen lies in the range from 1% to 30%, in particular in the range from 5% to 20% and preferably at 7% and is chosen to correspond to the fiber and nonwoven materials to be processed and with consideration for the pressures with which the bonding medium flows against the fiber and nonwoven material on the surface of the screen.

In the manufacture of nonwoven fabrics by means of the screen according to the invention, therefore, a nonwoven material is applied in a known way to the surface 11 of the screen, in order then to be subjected to a medium that presses the individual constituents of the nonwoven material against one another, intermingles them and so leads to a felting and bonding of the nonwoven material, which ultimately results in the forming of a web.

In the intermingling of the nonwoven material by the bonding medium used, that is to say by gas, water, aqueous and nonaqueous liquids, fiber material is also transported into the depressions 15, thereby causing the formation of the patterns projecting in the manner of a relief from the surface that is forming. When perpendicular or undercut side walls 17 are used, the relief-like patterns are given sharp contours, while the use of more or less gently inclined slopes results in the forming of a smoother relief.

If, as represented in the figures, through-openings 14 that widen conically toward the rear side are used, this results in a greater opening ratio in the region of the bottoms 16 of the depressions 15, which leads to a reduced flow resistance. As a result, the relief formation is further assisted, since the medium used for the bonding can flow away more quickly in the region of the depressions, whereby the transport of the nonwoven material into the depressions is assisted.

In particular when liquids are used, the increased opening ratio in the lower-lying regions, that is to say in the regions of the bottoms, improves the transporting away of the liquid, which makes a subsequent drying process easier.

A major advantage of the constant or widening cross sections of the through-openings 14 is that clogging of the through-openings is in this way virtually ruled out in practice, so that screens according to the invention can be used for the manufacture of non-woven fabrics over a longer period of time without servicing.

Apart from galvanically produced screens, the production of which is described in more detail below, screens may also be produced from metal, plastic and composite materials, such as glass-fiber reinforced plastics or resins or else carbon-fiber materials. It is also conceivable to reinforce plastics and natural materials that are suitable for layer formation with metal matrices or the like in a skeletal manner.

If screens are to be produced from such materials, the plates and cylinders provided for them can be provided with the through-openings 14 by means of laser radiation. In this case, through-openings 14 with cross sections widening toward the rear side 12 can be achieved by suitable adjustment of the focal point of the laser beam if the focal waist lies in the region of the upper side 11, so that the laser beam widens from the upper side 11 to the rear side 12. Depending on the depth of focus of the laser, the conical widening of the through-opening 14 can be set thereby.

The galvanic production of a screen according to the invention by a first method according to the invention is described below on the basis of FIGS. 5 and 1.

First, a screen body film 10′, which has a desired thickness, is produced in an electrolytic bath on a female mold, which is structured in conducting and nonconducting regions in a way corresponding to the desired screen. Once the screen body film 10′ has reached the desired thickness, it is pulled off from the female mold, in order to obtain a screen body 10 from the screen body film 10′ by depositing screen material in the electrolytic bath. As represented in FIG. 5(b), this may involve forming on the upper side of the screen funnel-shaped inlet regions 24 of the through-openings 14, which may, depending on the size of the through-openings 14 and/or the desired opening ratio of the screen, be left or be ground away.

Once the screen body 10 or screen blank is completed, the depressions 15 can then be carried out by etching, spark erosion, laser removal or by laser ablation. If a laser is used, is expedient if its wavelength is made to match the absorption properties of the screen body material respectively used.

If the depressions are to be produced by etching, an etching mask must first be applied to the screen body. For this purpose, the screen is first coated with an etching protection layer, which is then removed in the region to be etched, either by exposing and developing or once again by means of laser radiation. After appropriate material removal, the screen represented in FIG. 1 is then obtained from the screen body 10 or screen blank represented in FIG. 5.

According to another method according to the invention, after producing a screen body film 10′, as represented in FIG. 6(a), the screen body film 10′ is provided on the rear side and in the region of the depressions 15 to be formed with an electroplating protection layer, in order subsequently to deposit further screen material in the other regions in the electrolytic bath, so that a screen body precursor 10″ is formed, already provided with the desired depressions 15. Subsequently, after removing the electroplating protection layers, the screen body precursor 10″ is then brought to the final screen thickness d in the electrolytic bath.

In the case of the screens previously described, the ratio of the total surface area of the depressions 15, that is to say the ratio of the total surface area of the lower-lying regions, to the total surface area of the non-depressed regions is much less than 1, so that the resulting relief displays the raised relief-like pattern in the nonwoven fabric manufactured on the screen.

In the case of another exemplary embodiment of a screen according to the invention intended for regions impressed in the manner of a relief in the nonwoven fabric to be manufactured, raised portions or regions 18 are provided on the screen, as shown in FIGS. 7(a) and 7(b), the side walls 17 of said raised regions corresponding to the contours of the desired pattern, as can be seen in FIG. 7. The opening ratio of the screen in the region of the raised regions 18 is here preferably 0, i.e. the raised regions are not provided with openings. Here, therefore, the ratio of the lower-lying regions to the raised regions is the opposite of that above.

Also in the case of the screen, the through-openings 14 are once again provided with a constant cross section or a cross section widening toward the rear side 12 of the screen.

According to the invention, such a screen is produced by first forming the screen body 10 to the desired thickness of the screen, in order subsequently to be provided with an electrolytic mask, which only leaves free the regions on which screen material for the forming of the raised regions 18 according to the pattern is to be deposited in the electrolytic bath.

In the manufacture of a nonwoven fabric on such a screen, fiber and nonwoven material are transported from the region of the raised regions into the lower-lying regions, so that a tapered, depressed relief forms there in the finished nonwoven fabric.

Here, too, the shape of the through-openings provides the same advantages as the other exemplary embodiments of the invention.

If it is desired that the nonwoven fabric manufactured on the screen according to the invention not only has the relief-like pattern embossed with the depressions or raised regions but is also provided with a background pattern extending over the entire background of the material, that is to say the regions not provided with pattern, in order for example to simulate a woven or knitted fabric or the like, it is possible to etch the screen superficially, that is to say the upper side of the screen body, using a corresponding etching mask. For this purpose, depending on the production method used, the surface of the screen body can be etched before or after the forming of the depressions. In the production of a screen with raised regions, it is likewise possible to etch the upper side of the screen body before or after forming the raised regions using a correspondingly structured etching mask. If the structuring of the upper side of the screen body is performed after the forming of the depressions or raised regions, the background pattern also extends to the relief regions on the finished nonwoven fabric. Conversely, forming the structure intended for the background pattern before the forming of the embossing elements allows the effect to be achieved that the relief-like embossed regions do not have the same background structure, so that the relief stands out even more nicely.

1. A screen, in particular for manufacturing nonwoven fabrics by means of a gas jet or liquid jet bonding process, comprising a screen body (10) with an upper side (11) for applying a nonwoven material to be bonded and a rear side opposite from the upper side (11), the screen body (10) having a multiplicity of through-openings (14) running from the upper side to the rear side and also lower-lying regions (16) in the upper side (11) having contours that run in a way corresponding to a desired pattern, wherein the cross section of the through-openings (14) substantially remains the same or increases from the upper side (11) to the rear side (12).

2. The screen as claimed in claim 1, wherein the lower-lying regions (16) have a uniform depth (t), which is not greater than approximately three quarters of the thickness (d) of the screen body (10), preferably approximately equal to two thirds of the thickness (d) of the screen body (10).

3. The screen as claimed in claim 1, wherein the lower-lying regions (16) are bounded along their edges by side walls which either run substantially perpendicularly to the plane of the screen or are inclined in the manner of a slope at an angle of less than 45° to the perpendicular of the plane of the screen or form an undercut with an angle of less than 20° with respect to the perpendicular to the plane of the screen.

4. The screen as claimed in claim 1, wherein the opening ratio, that is to say the ratio of the surface area of all the openings to the total surface area of the screen, lies in the range from 1% to 30%, in particular in the range from 5% to 20%, preferably at 7%.

5. The screen as claimed in claim 4, wherein the opening ratio in the region of the lower-lying regions is the same as or greater than outside them.

6. The screen as claimed in claim 4, wherein the lower-lying regions (16) are interrupted by pattern-forming, raised regions (18), which protrude beyond the plane of the upper side of the screen body, the opening ratio in the region of the raised regions being at least less than the opening ratio in the region of the lower-lying regions (16), preferably equal to zero.

7. The screen as claimed in claim 1, wherein the cross section of the through-openings (14) is circular.

8. The screen as claimed in claim 1, wherein the cross section of the through-openings (14) is noncircular, in particular oval, elliptical or quadrangular.

9. The screen as claimed in claim 8, wherein the cross section of the through-openings (14) is slit-shaped.

10. The screen as claimed in claim 8, wherein the through-openings (14) are arranged with their longitudinal directions parallel to one another, alternately parallel and perpendicular to one another, or in randomized alignment to one another.

11. The screen as claimed in claim 1, wherein directly adjacent each through-opening (14) there lie six through-openings (14) that are spaced at equal intervals from one another.

12. The screen as claimed in claim 1, wherein adjacent each of the round through-openings (14) there lie three to ten through-openings (14) that are spaced at different intervals from one another.

13. The screen as claimed in claim 1, wherein the through-openings (14) are arranged in a randomized or pseudo-randomized manner in relation to one another.

14. The screen as claimed in claim 1, wherein the screen body (10) consists of metal, preferably of a metal that can be deposited on an electrode in an electrolytic bath, in particular of nickel, copper or aluminum or a mixture thereof.

15. A method for producing a screen, in particular as claimed in claim 1, with the following steps:
providing a screen body (10) with an upper side (11) for applying a nonwoven material to be bonded and a rear side (12) opposite from the upper side (11), the screen body (10) having a multiplicity of through-openings (14) running from the upper side (11) to the rear side (12), the cross section of which substantially remains the same or increases from the upper side (11) to the rear side (12), and
forming lower-lying regions (15) in the upper side (11) of the screen body (10) in a way corresponding to the desired pattern.

16. The method as claimed in claim 15, wherein the forming of the lower-lying regions (15) is performed by
applying an etching mask to the screen body (10) in a way corresponding to a desired pattern, and
subsequently etching the screen body (10) from the upper side (11) to a desired depth.

17. The method as claimed in claim 15, wherein the upper side of the screen body (10) is eroded to a desired depth according to a pattern to form the lower-lying regions (15).

18. The method as claimed in claim 15, wherein the formation of the lower-lying regions (15) is performed by removal according to a pattern or ablation according to a pattern of the screen body material from the upper side of the screen body by means of laser radiation.

19. The method as claimed in claim 18, wherein laser radiation of a wavelength corresponding to the absorption properties of the screen body material is chosen for the removal of the screen body material.

20. The method as claimed in claim 15, wherein the screen body is provided galvanically.

21. The method as claimed in claim 15, wherein a planar plate or a hollow cylinder of metal or non-metal is provided with a multiplicity of through-openings running from the upper side to the rear side by means of laser radiation to provide the screen body.

22. A method for producing a screen, in particular as claimed in claim 1, with the following steps:
providing a galvanic screen body film (10′) with an upper side (11′) and a rear side (12) opposite from it and also a multiplicity of through-openings (14),
applying an electroplating mask in a way corresponding to a desired pattern on the screen body film,
galvanically depositing screen body material outside the lower-lying regions (16) onto the upper side of the screen body film to a thickness that corresponds substantially to the later thickness of the lower-lying regions (16),
removal of the electroplating mask and
galvanically depositing screen body material on the resulting screen body structure (10″) to a thickness desired for the screen body (10) while retaining the through-openings (14) that run from the upper side (11) of the screen body (10) to its rear side (12).

23. A method for producing a screen, in particular as claimed in claim 6, with the following steps:
providing a galvanic screen body film (10) with an upper side and a rear side (12) opposite from it and also a multiplicity of through-openings (14),
applying an electroplating mask in a way corresponding to a desired pattern on the screen body film (10),
galvanically depositing screen body material outside the lower-lying regions (16) onto the upper side of the screen body (10) to a thickness that corresponds substantially to the later thickness of the lower-lying regions, and
removal of the electroplating mask.

24. The method as claimed in claim 15, wherein, after the forming of the lower-lying regions, the upper side (11) of the screen body (10) is etched using an etching mask in a way corresponding to a desired background structure of the nonwoven fabric to be manufactured.

25. The method as claimed in claim 15, wherein, before the forming of the lower-lying regions, the upper side (11) of the screen body (10) is etched using an etching mask in a way corresponding to a desired background structure of the nonwoven fabric to be manufactured.

26. The method as claimed in claim 23, wherein, before the application of an electroplating mask for galvanically depositing screen body material outside the lower-lying regions (16), the upper side (11) of the screen body (10) is etched using an etching mask in a way corresponding to a desired background structure of the nonwoven fabric to be manufactured.
